(19) United States
(12) Patent Application Publication
(10) Pub. No.: US 2017/0175822 A1
(43) Pub. Date: Jun. 22, 2017

(54) SYNCHRONIZATION UNIT FOR A GEAR CHANGING TRANSMISSION

(71) Applicant: OERLIKON FRICTION SYSTEMS (GERMANY) GMBH, Bremen (DE)

(72) Inventors: Marcus SPRECKELS, Oyten (DE); Robert BISSEX, MID GLAMORGAN (GB)

(73) Assignee: OERLIKON FRICTION SYSTEMS (GERMANY) GMBH, Bremen (DE)

(21) Appl. No.: 15/385,118

(22) Filed: Dec. 20, 2016

(30) Foreign Application Priority Data
Dec. 22, 2015 (EP) 15202011.1

(51) Int. Cl. F16D 23/04; F16D 23/02

(52) U.S. Cl. CPC F16D 23/04; F16D 23/025; F16D 2200/0021; F16D 2200/0026

(57) ABSTRACT

A synchronization unit of a switchable gear changing transmission for a vehicle. The synchronization unit includes a friction ring having an outer installation surface and a synchronizer ring having an inner installation surface. The outer installation surface of the friction ring is shaped as a first geometrically structured profile. The inner installation surface of the synchronizer ring is shaped as a corresponding second geometrically structured profile. The first profile of the friction ring is configured to engage with the second profile of the synchronizer ring in such a manner that the friction ring is secured in the radial direction to the axis and in the circumferential direction at the synchronizer ring.

### CROSS-REFERENCE TO RELATED APPLICATIONS

The present application claims priority under 35 U.S.C. §119(a) of European Patent Application No. 15202011.1 filed Dec. 22, 2015, the disclosure of which is expressly incorporated by reference herein in its entirety.

### BACKGROUND OF THE INVENTION

1. Field of the Invention

The invention relates to a synchronization unit of a switchable gear changing transmission for a vehicle. The invention also relates also to a friction ring for a synchronization unit and to a synchronizer ring for a synchronization unit.

2. Discussion of Background Information

In a mechanical switchable gear changing transmission, e.g., in vehicle transmissions, synchronization units serve to synchronize the relative speeds which occur between the gear wheel and the gear shaft during a gear change. The synchronization is achieved in this respect by friction between the corresponding friction partners. The function of such transmissions and the process of the synchronization are known per se and need not be explained in more detail to the person skilled in the art.

In order to prevent premature wear and/or to improve the frictional characteristic, it is known to provide the friction surfaces of the individual components of synchronization units, which are usually made of a metal or metal alloy such as brass or steel, with a friction layer. In this case, friction layers of completely different types are used, for example, thermal spray coatings of molybdenum, carbon friction coatings or friction coatings of other materials.

Synchronization units for gear changing transmissions, or individual components of synchronization units, have been described in a versatile and detailed manner in the prior art.

EP 2 894 363 A1, for example, shows a generic synchronization unit. This synchronization unit comprises a cone-shaped friction ring and a cone-shaped synchronizer ring, wherein the friction ring and the synchronizer ring are connected in an interlocking manner in the installed state. The friction ring has a conical outer installation surface with a first profile and the synchronizer ring has a corresponding conical inner installation surface with a second profile, wherein, in the installed state, the first profile engages into the second profile. The friction ring is secured via the conical inner installation surface of the synchronizer ring in the axial and radial direction to an axial axis of the synchronization unit. Furthermore, the friction ring comprises securing means against rotation ensuring that the friction ring is essentially connected also non-rotatably to the synchronizer ring, i.e., apart from little angular deflections occurring in a circumferential direction around the axial axis, the friction ring is connected non-rotatably to the synchronizer ring.

In order to explain this synchronization unit, reference is made to FIG. 1 to FIG. 3b of the instant application which show a prior art unit. In order to differentiate between the prior art and the present invention, the reference numerals which refer to features of known examples are marked with an apostrophe, whereas reference numerals which refer to features of examples of the invention have no apostrophe.

In the following description, the synchronization unit is designated as a whole with reference numeral 1′, the friction ring with reference numeral 2′ and the synchronizer ring with reference numeral 3′.

FIG. 1 shows an exploded view of a known synchronization unit 1′ comprising a friction ring 2′ and a synchronizer ring 3′. FIGS. 2a, 2b, 2c and 2d show in schematic representation one and the same embodiment of the friction ring 2′ illustrated in FIG. 1 of the known synchronization unit 1′. FIG. 2a shows the friction ring 2′ having a segmented friction ring body 4′ in an expanded configuration, whereas FIG. 2b shows the same friction ring 2′ in a compressed configuration. FIG. 2c shows a section along the line I-I according to FIG. 2a, whereas FIG. 2d shows a section of the friction ring 2′ according to FIG. 2a in a perspective view.

As can be recognized with reference to FIGS. 2a and 2b, the friction ring body 4′ in this embodiment is a segmented friction ring body 4′ which comprises a plurality of separate friction ring segments 41′, 42′, 43′, i.e., three friction ring segments 41′, 42′, 43′ which form the friction ring body 4′ in a ring-shaped arrangement. The friction ring 2′ can also consist of any other number of friction ring segments 41′, 42′, 43′.

According to FIG. 2c, the friction ring 2′ comprises a conical friction ring body 4′ having an inner friction surface 401′ and an outer installation surface 402′ which each bound the friction ring body 4′ in a radial direction extending perpendicular to an axial friction ring axis 5′. In this respect, the inner friction surface 401′ extends at a predefinable or predetermined friction angle α₁ and the outer installation surface 402′ extends at a predefinable installation angle α₂, in each case conically along the friction ring axis 5′. The friction angle α₁ can differ from the installation angle α₂.

As can be seen from FIG. 2d, a plurality of securing means against rotation 6′ or raised portions are provided on the friction ring body 4′ which extend along the friction ring axis 5′. The securing means against rotation 6′ are arranged evenly at the friction ring body 4′ in the circumferential direction U and engage in the installed state into corresponding indentations provided at the synchronizer ring 3′. The securing means against rotation 6′ ensure that the friction ring 2′ is essentially connected non-rotatably to the synchronizer ring 3′, i.e., as in known in the art, in the operating state of the synchronization unit 1′, the securing means against rotation 6′ prevent any rotation of the friction ring 2′ at the synchronizer ring 3′ in the circumferential direction U.

In the described example of the prior art, the interlocking coupling between the segmented friction ring and the synchronizer ring in the circumferential direction is achieved by a coupling based on indentations and raised portions extending in the axial direction. For this type of coupling, depending on the configuration, an additional axial space is necessary which cannot be used as friction surface.

This additional space required for the coupling can be saved if the interlocking coupling extends in the radial direction instead of axial direction. In this case the positive form (for example raised portions) can extend radially outwards at the segmented ring and engage into a negative form (for example indentations) at the synchronizer ring or vice versa, the positive form can extend radially inwards from the synchronizer ring and engage into a corresponding negative form at the segmented ring.

Also this type of interlocking coupling between the segmented friction ring and the synchronizer ring in the circumferential direction is shown in EP 2 894 363 A1. FIGS. 2a and 2b of EP 2 894 363 A1 show an embodiment of a synchronization unit 1′ where the securing means against rotation 6′ fastened at the friction ring 2′ do not extend in the axial direction but essentially perpendicular to the friction ring axis 5′. The securing means against rotation 6′ are shaped in the form of projections or teeth which project in the radial direction from the outer installation surface 402′ of the segmented friction ring 2′. Thus, the segmented friction ring 2′ comprises at its outer installation surface 402′ a first profile 7′ which is composed alternately of projections and recesses. Similarly, the synchronizer ring 3′ has at its inner installation surface 301′ a second profile having corresponding projections and recesses which extend also in the radial direction. In this embodiment of a synchronization unit 1′, the friction ring 2′ is essentially connected non-rotatably to the synchronizer ring 3′ by the securing means against rotation 6′, i.e., in the operating state of the synchronization unit 1′ the securing means against rotation 6′ prevent any rotation of the friction ring 2′ at the synchronizer ring 3′ in the circumferential direction U.

In FIG. 1, the synchronization unit 1′ further includes, in addition to the friction ring 2′ and the synchronizer ring 3′, in a manner known per se a sliding sleeve 10′ and a gear wheel 11′, wherein the aforesaid components are arranged coaxially to an axis 12′ of the synchronization unit 1′ such that the synchronizer ring 3′ can be displaced in the operating state by the sliding sleeve 10′ together with the friction ring 2′ along the axis 12′ in the direction towards the gear wheel 11′ so that the inner friction surface 401′ of the friction ring body 4′ can be brought into engagement with the gear wheel 11′.

Thanks to the described synchronization unit, several improvements have been made in practice.

Due to the fact that the interlocking coupling between the segmented/slitted (having slits) friction ring and the synchronizer ring in the circumferential direction extends in the radial direction instead of axial direction, it is possible to save the additional axial space which has been required for the coupling so far and thus could not be used as friction surface. As a result, compared to other synchronization units known in the art the axial extension of the synchronization unit has been essentially shortened.

However, it has also become evident that even this improved synchronization unit, which has proven itself in practice in the meantime, can be further improved.

A major disadvantage of the above-noted synchronization unit is that the effective surface for transferring force is limited to the individual securing means against rotation, i.e. the tooth flanks of the first and second profile, which are fastened at the friction ring or synchronizer ring. For this reason the friction ring is secured to the synchronizer ring in the circumferential direction only over a relatively small surface, namely the surface of the tooth flanks. As a consequence, the individual tooth flanks are subject to high mechanical stress which leads to increased wear or abrasion of the tooth flanks. In order to counteract the wear of the tooth flanks caused hereby, a complex, costly coating of the tooth flanks may be necessary.

As a result, there is a potential risk for the tooth flanks to get damaged due to the increased wear. For example, the tooth flanks can partially or completely break off the friction ring or synchronizer ring and thus a safe operation of the synchronization unit can no longer be ensured. In order to prevent damages at the tooth flanks, a complex surface curing of the tooth flanks or the use of expensive, high quality materials is often necessary.

Although the friction ring is secured against rotation in the circumferential direction in relation to the synchronizer ring, there is another disadvantage. The wear of the securing means against rotation leads to uncontrolled movements, i.e., little deflection(s), in the circumferential direction.

These uncontrolled movements of the friction ring at the synchronizer ring in the circumferential direction can, for example, lead to harmful vibrations and disrupt the reliability and accuracy of the synchronization. The cited effects are the more important the higher the synchronizing torque to be transmitted by the synchronization unit is.

A further disadvantage of the known synchronization unit is that sufficiently dimensioned teeth require a corresponding dimension in the radial direction. This leads to an increased radial dimension of the friction ring and the synchronizer ring, and thus of the whole synchronization unit, and thus of the whole gearbox.

Also, an essential disadvantage of the known synchronization unit is that due to its complex form, caused by the toothing or teeth, the friction ring or synchronizer ring can only be produced in a complex, expensive forging process or sintering process. Consequently, due to its complex geometry it is not possible to produce the friction ring or synchronizer ring in a simple and cost-effective deep-drawing process.

### SUMMARY OF THE EMBODIMENTS

Therefore, the invention aims to further improve a synchronization unit where the friction ring is secured at the synchronizer ring in the circumferential direction, wherein the force is transferred over a larger surface by causing lower wear in such a manner that uncontrolled movements between the friction ring and the synchronizer ring in the circumferential direction will be reduced and the synchronization unit has little structural dimensions in the axial and radial direction and the synchronization unit can be produced simpler, faster and with cheaper materials in such a manner that the disadvantages known in the prior art can be largely avoided. Another purpose of the invention is to provide an improved friction ring and an improved synchronizer ring for a synchronization unit.

The invention relates to a synchronization unit for a gear changing transmission of a vehicle comprising a friction ring having an outer installation surface and a synchronizer ring having an inner installation surface, wherein the outer installation surface and the inner installation surface extend at a predefinable installation angle conically along an axial axis of the synchronization unit, and the outer installation surface of the friction ring is shaped as a first geometrically structured profile extending in a circumferential direction around the axis and the inner installation surface of the synchronizer ring is shaped as a corresponding second geometrically structured profile in the circumferential direction, wherein in the installed state the first profile of the friction ring engages into the second profile of the synchronizer ring in such a manner that the friction ring is secured in the radial direction to the axis and in the circumferential direction at the synchronizer ring.

According to the invention the first profile of the friction ring and the second profile of the synchronizer ring of the synchronization unit are shaped each in the form of a curve trace segmented in the circumferential direction comprising a plurality of form segments being directly adjacent to one another, wherein the segmented curve trace with its form segments constitutes a continuous closed surface over at least a part of the circumference.

Within the scope of this invention the segmented curve trace with its form segments constitutes a continuous closed surface over at least a part of the circumference of the friction ring and/or of the synchronizer ring. If the friction ring and/or the synchronizer ring is shaped in one piece, without a slit, the segmented curve trace with its form segments constitutes a continuous closed surface over the whole circumference of the friction ring and/or synchronizer ring. If, however, the friction ring and/or synchronizer ring is shaped in one piece, with slit, or in two or more segments, the segmented curve trace with its form segments constitutes a continuous closed surface only over a part of the circumference of the friction ring and/or of the synchronizer ring, i.e., the continuous closed surface is only interrupted in the area of the slit and between the individual segments, respectively. Within the scope of the invention the segmented curve trace is only composed of form segments whose course is described by a constant mathematical function as seen in the circumferential direction. This is the difference to the prior art where the segmented curve trace is composed of form segments whose course is described by a discontinuous mathematical function as seen in the circumferential direction. As a result, the surface of a form segment has no projecting areas being solely responsible for the production of the synchronisation torque. Thus an increased effective contact surface between the friction ring and the synchronizer ring is provided which can be used for transferring the synchronization torque.

A significant advantage of the synchronization unit according to the invention is that an increased effective contact surface is provided between the friction ring and the synchronizer ring which can be used for transferring the synchronization torque. In principle, the whole available contact surface between the first profile of the friction ring and the second profile of the synchronizer ring can be used for transferring the force. Contrary to the prior art, the friction ring is secured at the synchronizer ring in the circumferential direction over a relatively large surface area of the segment surface. As a result, the mechanical stress for transferring the synchronization torque is spread onto this surface as a whole which has a positive effect on the wear or abrasion of the synchronization unit. For this reason neither a complex, costly coating of the segment surfaces nor the use of expensive, high quality materials are necessary.

Furthermore, there is no risk that damage caused by wear occurs at the synchronization unit. As a result, a safe operation of the synchronization unit is ensured.

Due to the low wear of the segment surfaces of both profiles there are—contrary to the prior art—no uncontrolled movements, i.e., little or small deflection(s), in the circumferential direction. As a result, harmful vibrations disturbing the reliability and accuracy of the synchronization can be prevented.

Thanks to the configuration of the first and second profile according to the invention the dimension of the friction ring and the synchronizer ring and thus of the whole synchronization unit and thus also of the whole gearbox remains low in the radial direction.

Furthermore, due to the configuration of the first and second profile according to the invention the rotation of the friction ring to the synchronizer ring in the circumferential direction is minimized.

A particular significant advantage of the invention is that due to the configuration of the first and second profile according to the invention, it is possible to produce the friction ring and/or synchronizer ring in a deep-drawing process. This makes the production of the synchronization unit simple and cost-effective.

It has proven to be particularly advantageous, if the individual form segments of the segmented curve trace are shaped as straight curves or profile sections, i.e., as straight profile sections, and/or curved profile sections, in particular, convex or concave curves or profile sections. The term convex means that the curve is bent against or curved outwardly relative to an axis of the synchronization unit, whereas the term concave means that the curve is bent in the direction of an axis of the synchronization unit or are inwardly curved. The individual form segments of the segmented curve trace can be identical or different. That means that the segmented curve trace can consist of only straight curves profile sections or, for example, only of bent curves or curved profile sections. Alternatively, it is also possible that the segmented curve trace can consists of or be comprised of straight curves or profile sections as well as of bent curves or curved profile sections.

In a preferred embodiment the segmented curve trace has a “spline-like” shape. Within the scope of this application the term “spline-like” means that the segmented curve trace in the circumferential direction is constant and differentiable over the whole length or is constant and differentiable only over the length of the respectively form segment, i.e., the segmented curve trace can be composed alternately of convexly and concavely bent curves. Thanks to the “spline-like” configuration of the segmented curve trace the first profile and the second profile can smoothly engage with one another, leading to a high transfer of force with low wear.

In an embodiment which is very significant in practice the segmented curve trace consists of or be comprised of straight curves like a polygon. The term “like a polygon” means that the segmented curve trace is shaped angularly with “n” corners and consists of or be comprised of a plurality of straight curves. The straight curves of the segmented curve trace can have the same length or different lengths. It has proven to be positive, if two adjacent straight curves are arranged at a polygonal angle of 120° to 170° to each other, wherein the polygonal angle is particularly preferably 150°.

Preferably, but not necessarily, the segmented curve trace is shaped rotationally symmetrically to the axis of the synchronization unit. This simplifies considerably the production and assembly of the synchronization unit.

It has also proven to be advantageous if a coating, in particular, a friction reducing coating such as a DLC (diamond-like carbon) coating is provided at the first profile and/or second profile. In an embodiment which is very important in practice the friction ring and/or synchronizer ring is shaped as a sheet metal part or a sintered steel part or a forged steel part or a forged brass part. This makes the production of the friction ring simple and inexpensive.

The synchronization unit according to the invention is used in a gear changing transmission for a vehicle, in particular, for a passenger vehicle, a transporter or a truck.

The present invention relates also to a friction ring for a synchronization unit according to the invention. The friction ring comprises a conical friction ring body having an inner friction surface and an outer installation surface which each bound the friction ring body in a radial direction extending perpendicular to an axial friction ring axis. The inner friction surface extends at a predefinable friction angle and the outer installation surface extends at a predefinable installation angle conically along the friction ring axis. The outer installation surface of the friction ring is shaped as a first geometrically structured profile in a circumferential direction extending around the friction ring axis.

According to the invention, the first profile is shaped in the form of a curve trace segmented in the circumferential direction comprising a plurality of form segments being directly adjacent to one another. The segmented curve trace with form segments constitutes a continuous closed surface over at least a part of the circumference of the friction ring body.

It has proven to be particularly advantageous, if the individual form segments of the segmented curve trace are shaped as straight curves and/or bent curves, particularly convex or concave curves.

In an embodiment, which has very significant advantages in practice, the segmented curve trace of the first profile consists of or is comprised of straight curves like a polygon. The term “like a polygon” means that the segmented curve trace is shaped angularly with n corners and consists of or is comprised of a plurality of straight curves. But it is also possible that the segmented curve trace of the first profile has a spline-like shape. Within the scope of this application the term “spline-like” means that the segmented curve trace in the circumferential direction is constant and differentiable over the whole length or is constant and differentiable only over the length of the respective form segment, i.e., the segmented curve trace can, for example, be alternately composed of convexly and concavely bent curves.

The present invention relates also to a synchronizer ring for a synchronization unit according to the invention. The synchronizer ring comprises a synchronizer ring body having an inner installation surface which extends at a predefinable installation angle conically along a synchronizer ring axis. The inner installation surface of the synchronizer ring is shaped as a second geometrically structured profile extending in a circumferential direction around the synchronizer ring axis.

According to the invention the second profile is shaped in the form of a curve trace segmented in the circumferential direction and comprising a plurality of form segments being directly adjacent to one another. The segmented curve trace with form segments constitutes a continuous closed surface over at least a part of the circumference.

It has proven to be particularly advantageous if the individual form segments of the segmented curve trace are shaped as straight curves and/or bent curves, in particular convex or concave curves.

In an embodiment which has very significant advantages in practice the segmented curve trace of the second profile consists of or is comprised of straight curves like a polygon. The term “like a polygon” means that the segmented curve trace is shaped angularly with n corners and consists of or is comprised of a plurality of straight curves. But it is also possible that the segmented curve trace of the second profile has a spline-like shape. Within the scope of this application the term “spline-like” means that the segmented curve trace in the circumferential direction is constant and differentiable over the whole length or is constant and differentiable only over the length of the respective form segment, i.e., the segmented curve trace can, for example, be alternately composed of convexly and concavely bent curves.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a synchronization unit known in the prior art;

FIG. 2a shows a first embodiment of a known segmented friction ring having axial securing means against rotation in an expanded configuration for a synchronization unit according to FIG. 1;

FIG. 2b shows the friction ring according to FIG. 2a in a compressed configuration;

FIG. 2c shows a section along the line I-I according to FIG. 2a;

FIG. 2d shows a section of the friction ring according to FIGS. 2a or 2b in a perspective view;

FIG. 3a shows a second embodiment of a known segmented friction ring having radial securing means against rotation;

FIG. 3b shows a section of the friction ring according to FIG. 3a in perspective view;

FIG. 4a shows a perspective view of an embodiment of a synchronization unit according to the invention;

FIG. 4b shows a perspective view of a synchronizer ring according to the invention for a synchronization unit according to FIG. 4a;

FIG. 4c shows a perspective view of a friction ring according to the invention for a synchronization unit according to FIG. 4a;

FIG. 4d shows a schematic view of the profile of the friction ring according to FIG. 4c;

FIG. 4e shows a cross-section of the unit shown in FIG. 4a using a sectioning plane passing through the unit and perpendicular to the center axis;

FIG. 4f shows a perspective cross-section of the unit shown in FIG. 4a;

FIG. 5a shows a schematic view of a profile of a second embodiment of a friction ring according to the invention;

FIG. 5b shows a schematic view of a profile of a third embodiment of a friction ring according to the invention;

FIG. 5c shows a schematic view of a profile of a fourth embodiment of a friction ring according to the invention; and

FIG. 5d shows a schematic view of a profile of a fifth embodiment of a friction ring according to the invention.

### DETAILED DESCRIPTION OF THE EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

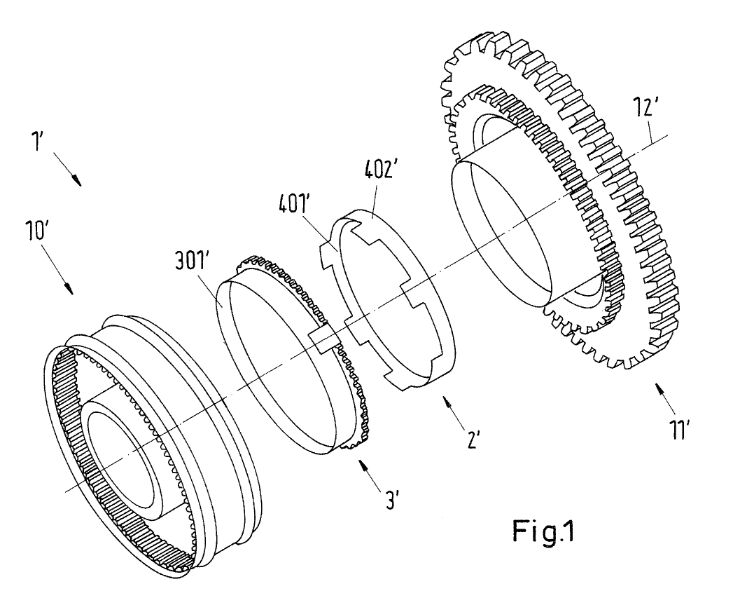

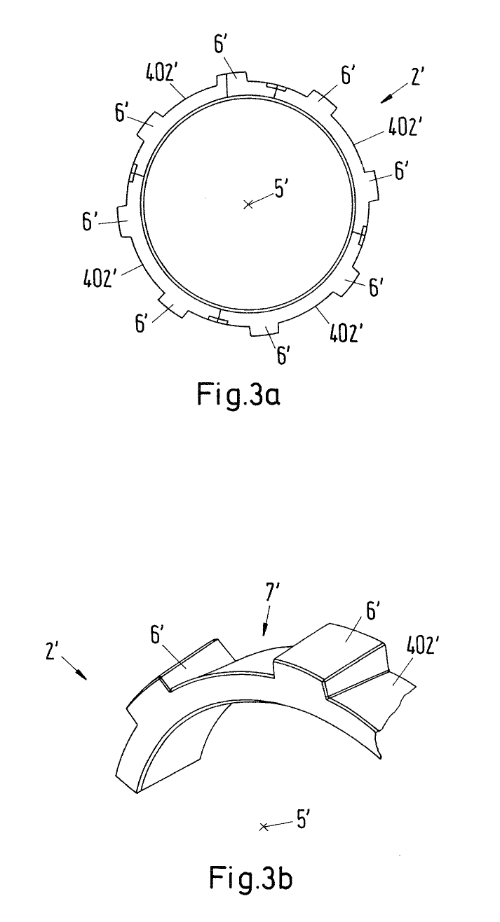

As mentioned above, FIGS. 1 to 3b show a prior art unit which has already been explained in detail so that any further discussion may not be considered necessary. It is emphasized, however, that the friction ring shown in FIGS. 3a and 3b includes distinct projections 6′ on the outer installation surface and these projections 6′ non-rotatably engage with distinct comparably shaped recesses in the synchronizer ring (not shown in FIGS. 3a and 3b). As will be evident from the below description, the invention uses a geometrically shaped profile for the installation surfaces (outer installation surface in the case of the friction ring and inner installation surface in the case of the synchronizer ring) which does not utilize distinct projections of the type shown in FIGS. 3a and 3b.

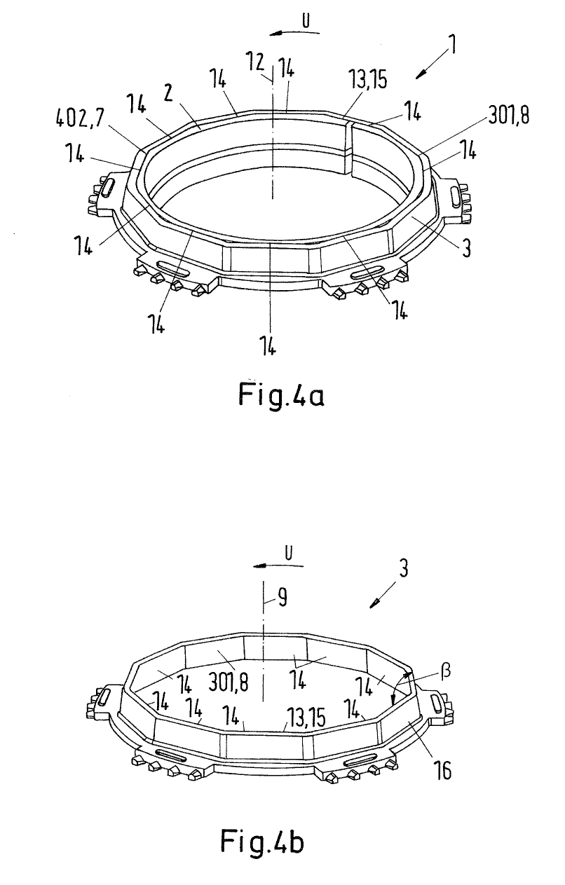

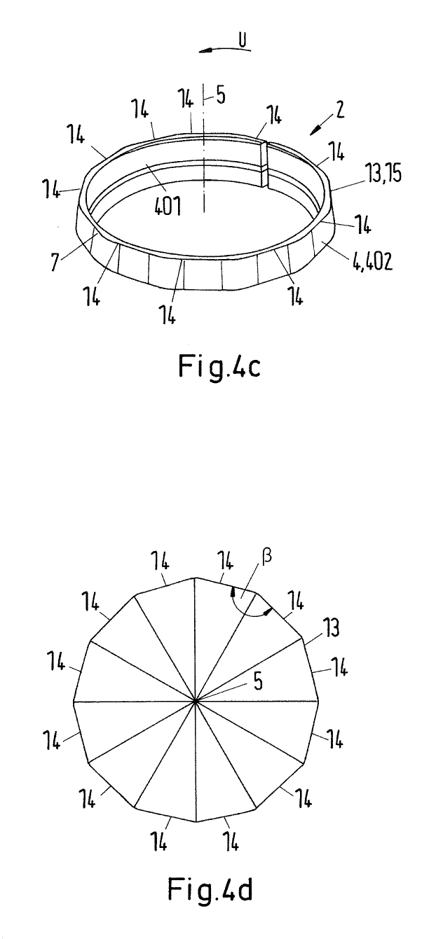

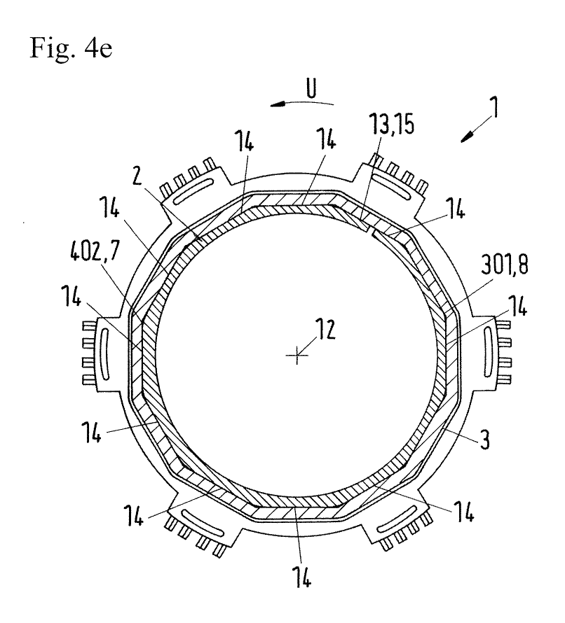

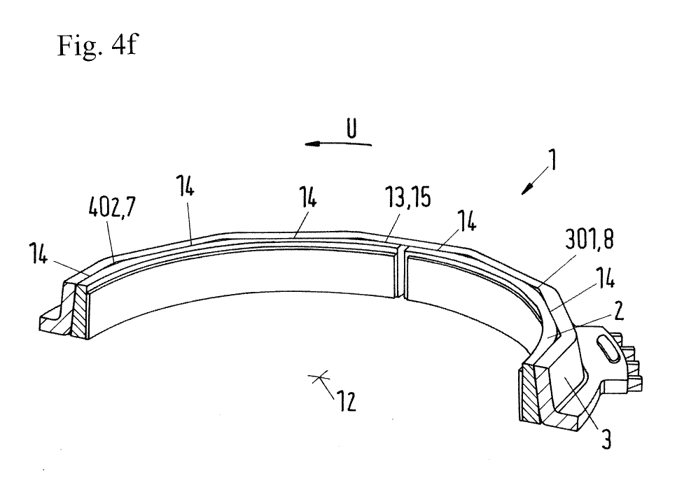

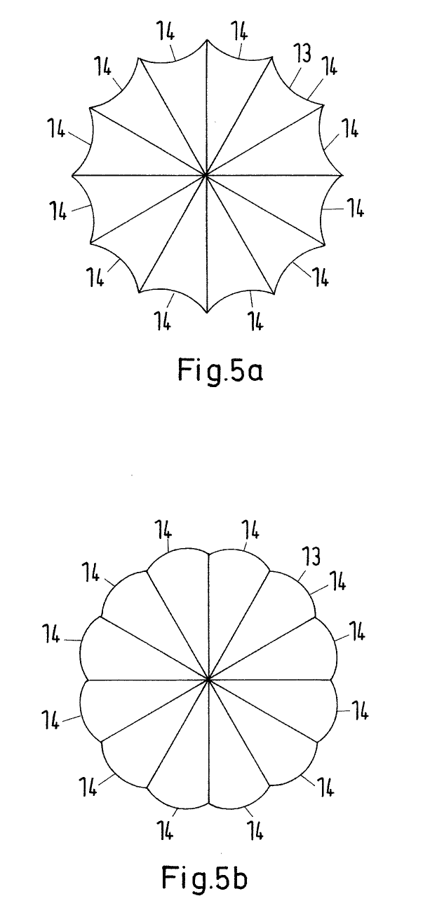

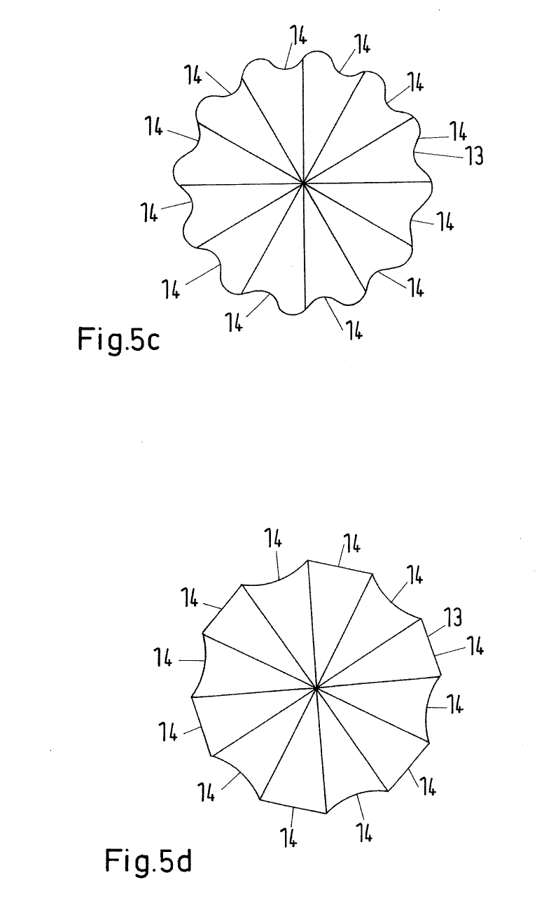

FIG. 4a shows in a perspective view a first embodiment of a synchronization unit according to the invention which is designated with reference numeral 1. The reference numerals used in FIG. 4a to FIG. 5d have no apostrophe and refer to embodiments of the present invention. As already mentioned above, reference numerals used in FIG. 1 to FIG. 3b have an apostrophe, because they refer to embodiments known in the art.

The synchronization unit 1 comprises in a manner known per se a generally cone-shaped friction ring 2 and a generally cone-shaped synchronizer ring 3 which can be assembled or connected to each other in an interlocking manner. The friction ring 2 can have a conical inner surface 401 and has a conical outer installation surface 402. The synchronizer ring 3 has a conical outer surface and a conical inner installation surface 301. The outer installation surface 402 and the inner installation surface 301 extend at a predefinable installation angle conically along an axial axis 12 of the synchronization unit 1. The outer installation surface 402 of the friction ring 2 is shaped (e.g., bent or deformed) so as to have a first geometrically structured profile 7 extending in a circumferential direction U around the axis 12, and the inner installation surface 301 of the synchronizer ring 3 is similarly shaped with a corresponding second geometrically structured profile 8 in the circumferential direction U. In the installed state (or assembled state shown in FIG. 4a) the first profile 7 of the friction ring 2 engages with or into the second profile 8 of the synchronizer ring 3 in such a manner that the friction ring 2 is secured in the radial direction relative to the axis 12 and in the circumferential direction U at the synchronizer ring 3. According to the invention, the first profile 7 and the second profile 8 are shaped each in the form of a segmented trace 13 in the circumferential direction U. The segmented trace 13 is made up of a plurality of profile segments 14 arranged directly adjacent to one another. These segments 14 are shaped to as to correspond to an imaginary circle or cone coaxial with the axis 12 and in contact with outermost portions of the respective installation surface 301 and 402. The friction ring 2 can have a slit in this embodiment to allow for radial and/or circumferential expansion/contraction. The segmented curve trace 13 with form segments 14 can otherwise constitute a continuous closed surface 15 over a part of the circumference of the friction ring 2, i.e., the continuous closed surface 15 can be almost entirely continuous or only interrupted in the area of the slit. This is different in the case of the synchronizer ring 3, which lacks a slit, such that where the segmented curve trace 13 with form segments 14 constitutes a continuous closed surface 15 over the whole circumference of the synchronizer ring 3. The friction ring 2 and the synchronizer ring 3 are thus essentially connected non-rotatably by the segmented curve trace 13 with form segments 14 of the first profile 7 and the segmented curve trace 13 with form segments 14 of the second profile 8, i.e., apart from little angular deflections in the circumferential direction U, the friction ring 2 is non-rotatably connected to and/or non-rotatably assembled to the synchronizer ring 3.

FIG. 4b and FIG. 4c show separately in a perspective view the synchronizer ring 3 and the friction ring 2 of the synchronization unit 1 according to the invention illustrated in FIG. 4a. As should be apparent, the friction ring 2 can have a conical inner surface 401 which does not have a shaped profile like that of the outer installation surface 402. On the other hand, the synchronizer ring 3 can have an outer installation surface that has a shaped profile like that of the inner installation surface 301. When assembled as shown in FIG. 4a, the profiled outer installation surface 402 can be said to be tapered and irregularly shaped and is configured to nest with and frictionally engage with the tapered and correspondingly irregularly shaped profiled inner installation surface 301. The correspondingly irregularly shaped profiles 7 and 8 can this prevent relative rotation between the ring 2 and ring 3 when these are assembled together. In the nested configuration shown in FIG. 4a, the ring 2 can be forced to move axially in one direction relative to the ring 3 until the slit is closed (the ends of ring 2 defining the slit contact one another) and also move back to an original or relaxed position with the slit assuming a predefined separated position such as that shown in FIG. 4a.

As shown in FIG. 4c, the friction ring 2 is a generally conical friction ring body 4 having an inner friction surface 401 and an outer installation surface 402, which each bound the friction ring body 4 in a radial direction extending perpendicular to an axial friction ring axis 5. The inner friction surface 401 extends at a predetermined friction angle and the outer installation surface 402 extends at a predetermined installation angle conically along the friction ring axis 5. The outer installation surface 402 of the friction ring 2 is shaped so as to have a first geometrically structured profile 7 extending in a circumferential direction U around the friction ring axis 5. As can be seen in FIG. 4c, the first profile 7 is not circular and is shaped in the form of a profile trace 13 that is segmented or sectioned in the circumferential direction U. The profile 7 has a plurality of form segments or sections 14 that are directly adjacent to one another. As the friction ring 2 has a slit in this embodiment, the segmented curve trace 13 with form segments 14 constitutes a continuous closed surface 15 over a part (or nearly all) of the circumference of the friction ring 2, i.e., the continuous closed surface 15 need only be interrupted in the area of the slit.

As can be appreciated from FIG. 4d, all of the segments 14 of the segmented curve trace 13 of the first profile 7 of the friction ring 2 can be shaped as straight sections or profile sides, i.e., straight profile segments or sections. Consequently, the segmented curve trace 13 can be shaped in the manner of a polygon. In the illustrated embodiment, the segmented curve trace 13 has twelve straight profile sections which are arranged at a polygonal angle 1 of 150° to each other. With such a configuration, the segmented curve trace 13 is shaped rotationally symmetrically relative to the friction ring axis 5.

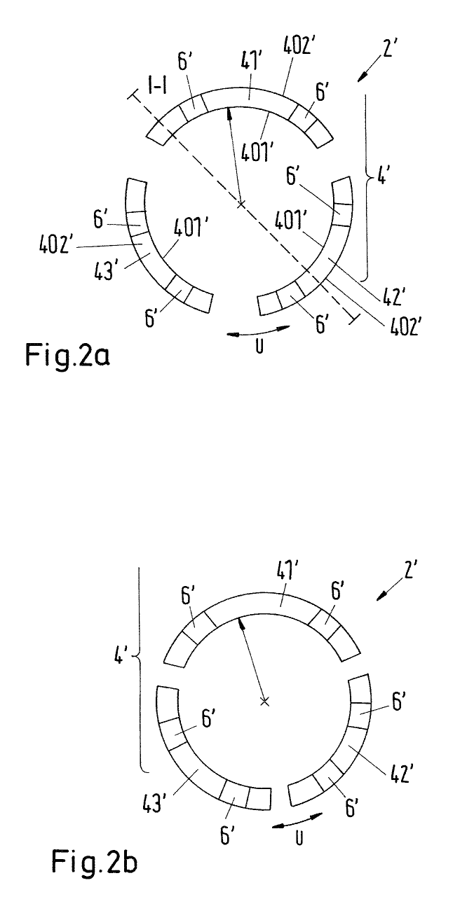

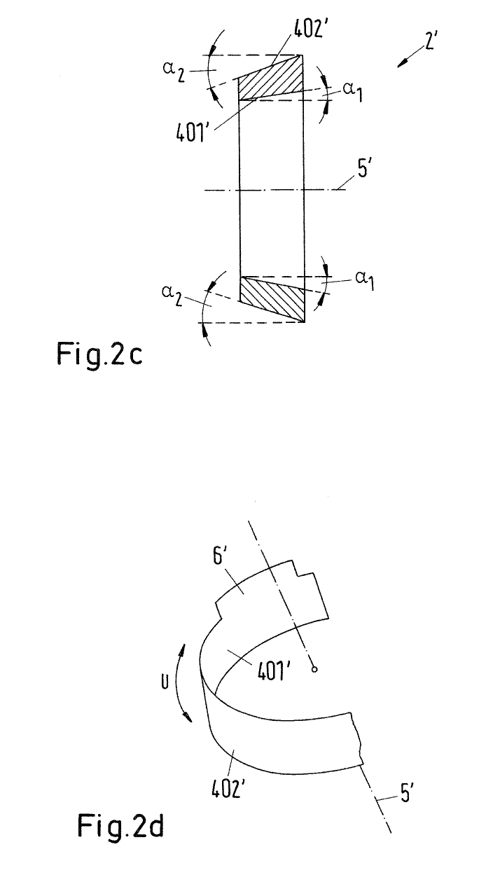

In this embodiment, the friction ring body 4 can be a one piece member with a slit, i.e., the segmented curve trace 13 with form segments 14 that constitute a continuous closed surface 15 over a part of the circumference of the friction ring body 4. It is also possible, as it is known in the art (see FIG. 2a and FIG. 2b), to form the friction ring body 4 from a plurality of separate friction ring segments which form the friction ring body 4 in a ring-shaped arrangement. These separate sections, however, would have the segmented curve trace 13 of the type disclosed herein such as having segments 14 that constitute a continuous closed surface 15 only over a part of the circumference of the friction ring body 4. Furthermore, it is possible to utilize a friction ring 2 that lacks a slit, wherein the segmented curve trace 13 with form segments 14 (see example of FIG. 4d) is a continuous closed surface 15 over the whole circumference of the friction ring 2.

Referring to FIG. 4b, it can be seen that the synchronizer ring 3 comprises a conical synchronizer ring body 16 having an inner installation surface 301 which extends at a predefinable installation angle conically along a synchronizer ring axis 9. The inner installation surface 301 of the synchronizer ring body 16 has a shaped second geometrically structured profile 8 extending in a circumferential direction U around the synchronizer ring axis 9. The second profile 8 has a shaped profile that generally corresponds to the first profile 7 of the friction ring 2. The second profile 8 is shaped to have a curve or profile trace 13 that is segmented in the circumferential direction U and comprising a plurality of form segments 14 that are directly adjacent to one another. However, unlike the first profile 7 of the friction ring 2 which can have a slit, the segmented curve trace 13 with form segments 14 that constitute a continuous closed surface 15 extend over the whole circumference because the synchronizer ring body 16 has no slit. If the first profile 7 of the friction ring 2 has all form segments 14 of the segmented curve trace 13 of the synchronizer ring 3 that are shaped as straight curves, it is preferred that the second profile 8 be similar shaped, i.e., if the first profile 7 is polygonal, the segmented curve trace 13 of the synchronizer ring 3 should be shaped like a polygon and, in conformity with the first profile 7 of the friction ring 2, can utilize twelve straight sections which are arranged at a polygonal angle β of 150° to each other. The segmented curve trace 13 should also be shaped rotationally symmetrically to the synchronizer ring axis 9.

The synchronization unit 1 illustrated in FIG. 4a shows a segmented curve trace 13 of the first profile 7 and of the second profile 8 which is shaped in each case like a polygon having twelve tapered and straight profile sections and having a polygonal angle β of 150°. Of course, the polygon can also be composed of another number of straight profile sections (either fewer or more that 12 and whether an even number of an odd number) or the straight curves can be arranged at another polygonal angle β to each other.

The friction ring 2 and the synchronizer ring 3 of the synchronization unit 1 shown in FIG. 4a can be each made of a sheet metal part or a sintered steel part. The first profile 7 of the friction ring 2 and the second profile 8 of the synchronizer ring 3 can also be provided with (or having at least partially arranged thereon) a coating such as a friction reducing coating such as a DLC coating.

FIG. 4a to FIG. 4d illustrate clearly that complex teeth or projection and recess elements are not required either on the outer installation surface 402 of the friction ring 2 or the inner installation surface 301 of the synchronizer ring 3.

FIGS. 5a to 5d show further embodiments of a segmented curve trace 13 according to the invention. The embodiments of the segmented curve trace differ from one another by the configuration and arrangement of the individual form or profile segments 14. All embodiments of a segmented curve trace shown in FIG. 5a to FIG. 5d can be applied in a synchronization unit according to the invention shown in FIG. 4a and specifically with respect to the installation surfaces 301 and 402. In the example shown in FIG. 4d, the straight profile segments 14 meet are corners which can be slight rounded, outwardly curved, or have a radius.

FIG. 5a shows a second embodiment of a segmented curve trace 13 according to the invention. Unlike the embodiment illustrated in FIG. 4a to 4d, the form segments 14 of the segmented profile trace 13 are not shaped as straight profile segments but are instead formed as tapered concave segments, i.e., the form 14 segments form a “spline-like” shape. The corners in this embodiment can be more sharp than that used in FIG. 4d or can be slightly rounded (outwardly curved).

As can be seen in FIG. 5b, it is also possible to shape the segments 14 of the segmented profile trace 13 to be tapered and convex instead of tapered and concave, i.e., in this case the form segments 14 are not bent or curved in the direction of axis 12 of the synchronization unit 1, but are instead bent against or curved outwardly from an axis 12 of the synchronization unit 1. The corners in this embodiment can be more sharp than that used in FIG. 4d or can be slightly rounded (inwardly curved).

As can be seen in FIG. 5c, it is also possible to make the segmented profile trace 13 to have a combination of tapered and convexly and concavely curved profile segments 14. Thus the segmented curve trace 13 has a spline-like shape in the circumferential direction over its whole length. This embodiment does not utilize corners unlike other embodiments and resembles a gear with tapered and rounded teeth.

FIG. 5d shows another embodiment wherein the segmented profile trace 13 utilizes a combination of alternating straight sections 14 and bent or inwardly curved sections 14. The corners in this embodiment can be more sharp than that used in FIG. 4d or can be slightly rounded (outwardly curved).

In the embodiments shown in FIG. 5a to 5d, the segmented profile trace 13 with form segments 14 can be a continuous closed surface over the whole or nearly whole circumference of the friction ring 2 and the synchronizer ring 3, respectively.

It is also possible that the segmented profile trace 13 with form segments 14 can constitute a continuous, closed surface only over a part of the circumference of the friction ring and the synchronizer ring, respectively.

As should be apparent, FIG. 5a to FIG. 5d illustrate clearly that the segmented profile trace 13 according to the invention can be composed of form segments of different geometry or that form segments of different geometry that can be combined to form the segmented profile trace according to the invention.

As can be noted from FIGS. 4e and 4f, the wall thickness of sections 14 of the friction ring 2 (which is disposed inside the synchronizer ring 3) can increase (in the case of FIGS. 4d and 5a) gradually and continuously from a middle of each section 14 to ends thereof which can define areas or zones of maximum wall thickness. The wall thickness of sections 14 of the friction ring 2 can also decrease (in the case of FIG. 5b) gradually and continuously from a middle of each section 14 to ends thereof which can define areas or zones of minimum wall thickness. A combination of gradual increasing and decreasing wall thickness can result from the shapes shown in FIGS. 5c and 5d. This is different from the prior art friction ring shown in FIGS. 3a and 3b which has distinct projections 6′ of constant wall thickness in a comparable cross-sectioning plane, and which extend to perpendicular side surfaces. With respect to the synchronizer ring 3, the wall thickness in cross-section can be, in non-limiting embodiments (as shown in FIG. 4e) a substantially constant wall thickness, especially in regards to sections 14. As is also apparent from FIG. 4f, the friction ring 2 can utilize a coating on the inner conical surface. As noted in the above Summary, a coating can also be arranged on the outer conical surface of the friction ring 2 as well as on an inner conical surface of the synchronizer ring 3. It should also be apparent from FIGS. 4e and 4f, that the inner surface (or profile) of the friction ring can generally or approximately correspond in shape (e.g., cross-sectional shape) to the outer installation surface and also that the outer surface (or profile) of the synchronizer ring can generally or approximately correspond in shape (e.g., cross-sectional shape) to the inner installation surface of the synchronizer ring.

In the illustrated embodiments of the segmented profile trace according to the invention, the segmented profile trace has a non-circular cross-section and is shaped rotationally symmetrically to the axis of the synchronization unit. There are, of course, other conceivable embodiments where the segmented profile trace is shaped non-rotationally symmetrically to the axis of the synchronization unit.

What is claimed:

1. A synchronization unit for a gear changing transmission of a vehicle, said unit comprising:
a friction ring having an outer installation surface;
the outer installation surface having a first geometrically structured profile extending in a circumferential direction around an axial axis of the friction ring and extending at a predetermined installation angle relative to the axial axis;
a synchronizer ring having an inner installation surface;
the inner installation surface having a second geometrically structured profile extending in a circumferential direction around an axial axis of the synchronizer ring and extending at a predetermined installation angle relative to the axial axis; and
said axial axis of the friction ring being coaxial with said axial axis of the synchronizer ring,
wherein, in an installed state, first segments of said first profile radially and circumferentially engage with second segments of said second profile.

2. The unit of claim 1, wherein segments of the first profile comprise at least one of:
straight segments;
outwardly curved segments;
convex segments;
inwardly curved segments; or
concave segments.

3. The unit of claim 1, wherein segments of the first profile comprise at least one of:
straight segments;
outwardly curved segments;
convex segments;
inwardly curved segments; or
concave segments.

4. The unit of claim 1, wherein said first profile is polygonal.

5. The unit of claim 1, wherein said second profile is polygonal.

6. The unit of claim 1, wherein the first segments of said first profile comprises adjacent straight segments arranged at an angle (β) of between 120° and 160°.

7. The unit of claim 1, wherein the second segments of said second profile comprises adjacent straight segments arranged at an angle (β) of between 120° and 160°.

8. The unit of claim 1, wherein the first segments of said first profile and segments of said second profile have a same shape.

9. The unit of claim 1, wherein alternating segments of said first profile and alternating segments of said second profile have a same shape.

10. The unit of claim 1, wherein the first segments of said first profile comprise at least two adjacent segments having different shapes.

11. The unit of claim 1, wherein the second segments of said second profile comprise at least two adjacent segments having different shapes.

12. The unit of claim 1, wherein the friction ring is at least one of:
a split ring;
a ring with spaced-apart ends; and
a ring that can expand or contract radially and circumferentially.

13. The unit of claim 1, wherein at least one of:
the outer installation surface comprises one of:
a coating; and
a friction reducing coating; and
the inner installation surface comprises one of:
a coating; and
a friction reducing coating.

14. The unit of claim 1, wherein the friction ring is one of:
a sheet metal part;
a sintered steel part;
a forged steel part; or
a forged brass part.

15. The unit of claim 1, wherein the synchronizer ring is one of:
a sheet metal part;
a sintered steel part;
a forged steel part; or
a forged brass part.

16. A gear changing transmission for a vehicle or a passenger vehicle, comprising:
a transmission; and
a synchronization unit in accordance with claim 1.

17. A friction ring for a synchronization unit, said friction ring comprising:
an outer installation surface that has a first geometrically structured profile extending in a circumferential direction around an axial axis and is segmented and extends at a predetermined installation angle relative to an axial axis of the synchronization unit; and
the outer installation surface being configured to engage with an inner installation surface having a correspondingly shaped second geometrically structured profile of a synchronizer ring,
wherein, in an installed state, segments of said first profile are configured to radially and circumferentially engage with segments of said second profile.

18. The ring of claim 17, wherein segments of the first profile comprise at least one of:
straight segments;
outwardly curved or convex segments; and
inwardly curved or concave segments.

19. A synchronizer ring for a synchronization unit, said synchronizer ring comprising:
an inner installation surface that has a first geometrically structured profile extending in a circumferential direction around an axial axis and extends at a predetermined installation angle relative to an axial axis of the synchronization unit; and
the inner installation surface being configured to engage with an outer installation surface having a correspondingly shaped second geometrically structured profile of a friction ring,
wherein, in an installed state, segments of said first profile are configured to radially and circumferentially engage with segments of said second profile.

20. The ring of claim 19, wherein segments of the first profile comprise at least one of:
straight segments;
outwardly curved segments;
convex segments;
inwardly curved segments; or
concave segments.
